(19) United States
(12) Patent Application Publication
(10) Pub. No.: US 2020/0346216 A1
(43) Pub. Date: Nov. 5, 2020

(54) TUBING ASSEMBLY

(71) Applicant: LABOMATIC Instruments AG, Allschwil (CH)

(72) Inventor: Claude Louis Marchand, Holstein (CH)

(21) Appl. No.: 16/643,348

(22) PCT Filed: Aug. 28, 2018
(86) PCT No.: PCT/EP2018/073113

§ 371 Date: Feb. 28, 2020

(30) Foreign Application Priority Data
Aug. 29, 2017 (DE) 10 2017 119 841.5

(51) Int. Cl. B01L 3/00; F16L 11/04

(52) U.S. Cl. CPC B01L 3/561; B01L 2200/12; B01L 2300/0832; F16L 11/04

(57) ABSTRACT

The invention relates to a tube assembly comprising at least two tubes arranged in at least one plane at predefined distances and to a casing covering the tubes in the longitudinal direction.

### RELATED APPLICATION

The present application is the national stage entry of international application no. PCT/EP2018/073113 filed Aug. 28, 2018 which claims priority to Application No. 10 2017 119 841.5 filed Aug. 29, 2017, both of which are incorporated herein by reference.

### FIELD

The present invention relates to a tubing arrangement for fluid handling devices for use in analysis or in medical diagnosis, e.g. in liquid chromatography.

### BACKGROUND

Tubings that are used for the transport of liquids in the above-said devices have to have diameters with tight tolerances in the range of a few hundredth millimeters to ensure an exactly dimensioned throughput of the liquids; they have to be chemically resistant to withstand a plurality of substances; they have to prevent the attachment of residues and microbes as much as possible to satisfy demands with respect to hygiene and analysis precision; they have to be robust to have a long service life in an automated environment; and they must be easy to process and install for the technician—and all this at a favorable price. Plastics have proven to be suitable for this. Exemplary materials for such tubings are polyether ether ketone (PEEK) or silicone or fluoropolymers such as tetrafluoroethylene-perfluoropropylene copolymers or tetrafluoroethylene-hexafluoropropylene copolymers (FEPs).

Automated liquid handling devices, so-called liquid handling systems, such as are manufactured and marketed by the applicant are used purely by way of example, e.g. at liquid chromatographs to simultaneously introduce different fractions from the chromatograph into different test tubes or microtiter plates arranged in an array and also to remove them therefrom again in an automated manner. The liquid handling device for this purpose successively moves a dispensing head having a plurality of outlets for the different fractions over the array of test tubes or microtiter plates and dispenses the corresponding fractions into the test tubes or removes them therefrom. For this purpose to date, respective individual tubings for the respective fractions have previously been led from the removal point at the liquid chromatograph to the corresponding point at the head of the liquid handling device. As a rule, there are 4 to 8 tubings that have to be laid more or less loosely to be able to follow the movement of the dispensing head over the array.

It is, however, laborious to have to lay every tubing individually. In addition, special care must be taken that the individual tubings do not impede one another in the course of the movement of the dispensing head and possibly move into moving parts of the liquid handling device and damage them or are themselves damaged.

Attempts have been made to produce tubings having multiple passages to solve this problem. It has, however, been found that such tubings do not meet the demands with respect to the exact cross-section of every single passage. Attempts to connect individual tubings to one another in the longitudinal direction were also unsuccessful due to the materials to be used.

### SUMMARY

It is therefore the underlying object of the invention to provide a tubing arrangement that provides an improved arrangement of tubings in a cost-favorable manner while maintaining the required high cross-section accuracy, but with improved handling, and to provide a method of manufacturing same.

The method in accordance with the invention should in particular be usable with any desired number of tubings, i.e. from two to 3, four to 8, or even more tubings.

This object is satisfied by a tubing arrangement in accordance with claim 1, by a liquid handling device in accordance with claim 9, and by a method of manufacturing a tubing arrangement in accordance with claim 10.

Further advantageous embodiments are set forth in the dependent claims.

### DRAWINGS

The invention will be described by way of example in the following with reference to the drawings in which there are shown:

FIG. 1 a three-dimensional view of a front end section of a first embodiment of a tubing arrangement in accordance with the invention;

FIG. 2 a cross-section through the first embodiment of the tubing arrangement in accordance with the invention;

FIG. 3 a cross-section through a second embodiment of a tubing arrangement in accordance with the invention;

FIG. 4 a cross-section through a third embodiment of a tubing arrangement in accordance with the invention;

FIG. 5 a cross-section through a fourth embodiment of a tubing arrangement in accordance with the invention; and

FIG. 6 a cross-section through a fifth embodiment of a tubing arrangement in accordance with the invention.

### DETAILED DESCRIPTION

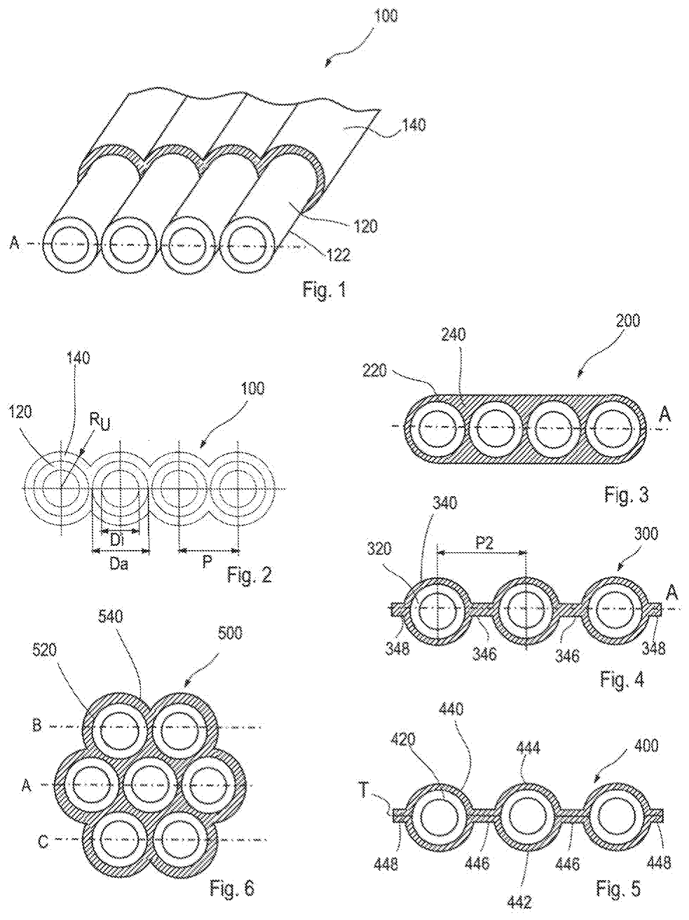

FIG. 1 shows a three-dimensional view of a front end section of a first embodiment of a tubing arrangement 100 in accordance with the invention. The rear part, in which the tubing arrangement 100 is wound onto a roll, is not shown in the drawing. Such a roll can take up 50 m of tubing and can have a winding width of 200 mm and a winding diameter of 250 mm. The tubing arrangement 100 consists of four tubings 120 that are arranged in a plane A and that are manufactured from plastic such as polyether ether ketone (PEEK) or silicone or fluoropolymers; in the present case, for example, tetrafluoroethylene-perfluoropropylene copolymer (FEP). The tubings 120 are provided with a jacket 140. The material of the jacket 140; 240; 340; 440; 540 is preferably plastic such as polyurethane (PU) or polyvinyl chloride (PVC) or silicone, in the present case PVC having a hardness of 75 Shore A, so that the tubing arrangement 100 remains approximately as flexible as the individual tubings overall. The front part of the jacket 140 has been removed so that the tubings 130 are exposed at their front end sections 122. Fittings, not shown, can be fastened to these exposed end sections 120, for example by crimping. These fittings then enable the connection of the tubings, e.g. to the pipettes, to be able to take up and dispense liquids through the tubings.

FIG. 2 shows a cross-section through the first embodiment of the tubing arrangement 100 in accordance with the invention. The tubings 120 are arranged at a defined spacing P from one another. The tubings 120 have an inner diameter Di that e.g. amounts to 2 mm with a tolerance of +/−5/100 mm in a practical application. The outer diameter Da of the tubings 120 amounts to e.g. 3 mm. The radius RU of the jacket 14 amounts to approximately 2 mm so that the resulting thickness of the jacket amounts to approximately 0.5 mm.

The tubing arrangement 100 of FIGS. 1 and 2 is produced in that four tubings 120 are unwound from tubing rolls arranged next to one another and are placed next to one another into an extrusion tool at a defined spacing P from one another. The tubing rolls can, for example, each bear a rolled up tubing length of 250 m, 500 m, 1000 m, or more. The plastic composition forming the jacket is injected into a hollow space formed between the tubings 120 and the extrusion tool while the tubings 120 are simultaneously drawn through the tool and thus serve as mandrels. The tubings 120 having the jacket layer 140 thereon that exit the tool are in turn wound onto a roll as the desired tubing arrangement 100 after cooling.

In the case of the embodiment of the tubing arrangement 100 in accordance with FIGS. 1 and 2, the outer contour of the tubing arrangement 100 is selected such that recesses of the corrugations optionally fit into elevated portions of a drag chain with which liquid handling devices are frequently equipped to lead tubings and data cables and power cables flexibly and in a protected manner to a moving dispensing head. The tubing arrangement 100 is thus securely led in the drag chain and there is no longer the risk that individual tubings enter into the mechanism of the liquid handling device. The drag chain can even be replaced with the tubing arrangement 100 since the jacket 140 takes over the function of leading and protecting the tubings 120.

A desired length of the tubing arrangement 100 is drawn off the roll and cut off for the tailoring of the tubing arrangement 100 to be installed. The ends of the tubing arrangement 100 are prepared for the connection of fittings in that the jacket 140 is given an incision a few centimeters from the respective ends of the cut-off tubing arrangement 100 up to the outer diameter Da of the tubings 120 located therein and the jacket 140 is then pulled off over the tubings 120 from the end of the tubing arrangement 100 up to the incision in the jacket 140. End sections 122 of the tubings 120 are now exposed and can be provided with fittings in the desired manner. The tubing end sections 122 can for this purpose, for example, be led through threaded sleeves and can be crimped.

FIG. 3 shows a cross-section through a second embodiment of a tubing arrangement 200 in accordance with the invention of four tubings 220 arranged next to one another in a plane A and one jacket 240. The jacket 240 here does not have the same thickness everywhere, but a smooth outer contour without recesses is rather provided that can be advantageous depending on the desired application.

FIG. 4 shows a cross-section through a third embodiment of a tubing arrangement 300 in accordance with the invention of three tubings 320 arranged next to one another in a plane A and one jacket 340. The jacket 340 forms webs 346, 348 between the individual tubings 320 and at the side of the outermost tubings. A desired spacing P2 between the tubings 320 can be established via the webs 346 between the tubings 320. The spacing between the tubings 320 can thus be increased via the webs 346 so that there is more space for the fittings to be fastened to the tubings and a defined spacing is ensured between the fittings without the tubings 320 having to be bent away from one another.

FIG. 5 shows a cross-section through a fourth embodiment of a tubing arrangement 400 in accordance with the invention that has a similar design to the tubing arrangement 300 of FIG. 4. Three tubings 420 are again arranged in a plane and are sheathed with a jacket 440. The jacket 440 forms webs 448 at the marginal side and central webs 446 between the individual tubings 420 and consists of two jacket halves 442, 444 that contact one another at a dividing line T that forms the plane in which the three tubings 420 are arranged.

The tubings 42 are placed into the lower jacket half 442 next to one another and the upper jacket half 444 is placed thereon to establish this tubing arrangement. Depending on the choice of material, there is the possibility of adhesive bonding at the dividing line T for the connection of the jacket halves 442 so that adhesive has to be applied to one or both contacted surfaces of the jacket halves 442, 444 before the two halves are put together or there is the possibility of welding, e.g. via ultrasound, when the material of the jacket is weldable. The sonotrodes of the ultrasound welding device are in this case placed onto the webs 446, 448 or are rolled over the webs 446, 448 as roller sonotrodes.

FIG. 6 shows a cross-section through a fifth embodiment of a tubing arrangement 500 in accordance with the invention that consists of seven tubings 520 and one jacket 540. The tubings 520 are in this case, however, not only arranged next to one another in one plane A, but also additionally in two further planes B and C.

It must be noted that it can be advantageous for the connection of the individual tubings during assembly if they have an individual color or code to ensure the association of the respective ends.

### REFERENCE NUMERAL LIST

A, B, C plane
Di inner tubing diameter
Da outer tubing diameter
Ru radius of jacket
P, P2 hosing spacing
T dividing line
100; 200; 300; 400; 500 tubing arrangement
120; 220; 320; 420; 520 tubing
122 end section
140; 240; 340; 440; 540 jacket
346, 348; 446, 448 webs

1.-10. (canceled)

11. A tubing arrangement comprising
at least two tubings arranged at predefined spacings in at least one plane; and
a jacket surrounding the tubings in the longitudinal direction.

12. The tubing arrangement in accordance with claim 11,
wherein the tubings are manufactured from plastic such as polyether ether ketone or silicone or fluoropolymers, e.g. tetrafluoroethylene-perfluoropropylene copolymers; and
wherein the jacket is manufactured from plastic such as polyurethane or polyvinyl chloride or silicone.

13. The tubing arrangement in accordance with claim 12,
wherein the plastic of the tubing comprises one of polyether ether ketone, silicone, fluoropolymers, and tetrafluoroethylene-perfluoropropylene copolymers.

14. The tubing arrangement in accordance with claim 12,
wherein the plastic of the jacket comprises one of polyurethane, polyvinyl chloride and silicone.

15. The tubing arrangement in accordance with claim 11,
wherein the jacket is manufactured by extrusion around the tubings by means of an extrusion tool or by molding the tubings by means of injection molding or by connecting two jacket halves while interposing the tubings by means of adhesive bonding, ultrasound welding, or the like.

16. The tubing arrangement in accordance with claim 11,
wherein end sections of the tubings can be exposed by making an incision in the jacket up to the outer diameter of the tubings and pulling off the end sections of the jacket thereby cut off from the end sections of the tubings.

17. The tubing arrangement in accordance with claim 16,
wherein fittings can be attached to the end sections of the tubings.

18. The tubing arrangement in accordance with claim 11,
wherein the individual tubings of the tubing arrangement have one of an individual color and a code.

19. The tubing arrangement in accordance with claim 11,
wherein the outer contour of the jacket having the tubings located therein is adapted such that it complements the outer contour of a drag chain that is used in connection with the tubing arrangement at a liquid handling device for use in analysis or in medical diagnosis, for instance in liquid chromatography.

20. The tubing arrangement in accordance with claim 11,
wherein the tubing arrangement replaces a drag chain that is used at a liquid handling device for use in analysis or medical diagnosis.

21. A liquid handling device for use in analysis or medical diagnosis, the liquid handling device having a tubing arrangement, the tubing arrangement comprising
at least two tubings arranged at predefined spacings in at least one plane; and
a jacket surrounding the tubings in the longitudinal direction.

22. A method of manufacturing a tubing arrangement that comprises the following steps:
providing at least two tubings of plastic in at least one plane, starting from a tubing roll or tubing precuts; and
sheathing the provided tubings with a jacket of plastic by one of extrusion in an extrusion tool, injection molding in an injection molding mold, and embedding the tubings into two jacket halves and by subsequent adhesive bonding or welding of the jacket halves.

23. The method of claim 22,
wherein the plastic of the tubing comprises one of polyether ether ketone, silicone, fluoropolymers and tetrafluoroethylene-perfluoropropylene copolymers.

24. The method of claim 22,
wherein the plastic of the jacket comprises on of polyurethane, polyvinyl chloride, and silicone.
